(19) United States
(12) Patent Application Publication
(10) Pub. No.: US 2024/0307919 A1
(43) Pub. Date: Sep. 19, 2024

(54) ULTRASONIC TRANSDUCER

(71) Applicant: NITERRA CO., LTD., Nagoya-shi, Aichi (JP)

(72) Inventors: Toshihito SONOBE, Nagoya-shi, Aichi (JP); Asuka TSUJII, Nagoya-shi, Aichi (JP); Ryo SUZUKI, Nagoya-shi, Aichi (JP); Yuichiro HANAWA, Nagoya-shi, Aichi (JP); Shinsuke ITOH, Nagoya-shi, Aichi (JP); Takashi KASASHIMA, Nagoya-shi, Aichi (JP)

(73) Assignee: NITERRA CO., LTD., Nagoya-shi, Aichi (JP)

(21) Appl. No.: 18/576,290

(22) PCT Filed: Aug. 9, 2022
(86) PCT No.: PCT/JP2022/030394

§ 371 Date: Jan. 3, 2024

(30) Foreign Application Priority Data
Aug. 20, 2021 (JP) 2021-134551

(51) Int. Cl. B06B 1/06

(52) U.S. Cl. CPC B06B 1/0648

(57) ABSTRACT

An ultrasonic transducer (1) includes a base portion (14), a piezoelectric element (11), a vibration plate (10), and a resonator (12). The resonator (12) is joined to a first surface (21) of the vibration plate (10). A surface, of the piezoelectric element (11), on a side opposite to a side on which the piezoelectric element is joined to the base portion (14), is joined to a second surface (22) of the vibration plate (10). A through-hole (30) is formed in the piezoelectric element (11) so as to penetrate therethrough in a thickness direction of the vibration plate (10). In a planar direction orthogonal to the thickness direction of the vibration plate (10), a joined portion (40) between the vibration plate (10) and the resonator (12) is located inward of a node (20) of vibration of the vibration plate (10), and the through-hole (30) is located inward of the node (20).

### TECHNICAL FIELD

The present disclosure relates to an ultrasonic transducer.

### BACKGROUND ART

Patent Document 1 discloses an ultrasonic transducer. The ultrasonic transducer includes: a piezoelectric vibrating body obtained by joining a piezoelectric body and a metal to each other with an adhesive; and a funnel-like resonator fixed to the piezoelectric vibrating body. The piezoelectric vibrating body is fixed onto a base member with a buffer member interposed therebetween.

### PRIOR ART DOCUMENT

### Patent Document

Patent Document 1: Japanese Patent Application Laid-Open (kokai) No. 2001-258098

### SUMMARY OF THE INVENTION

### Problem to be Solved by the Invention

In this type of ultrasonic transducer, when the ultrasonic transducer is driven, the resonator vibrates so that stress is easily applied to the piezoelectric body (piezoelectric element) at around a joined portion between the resonator and the metal (vibration plate). Therefore, there is a concern that, for example, the piezoelectric body (piezoelectric element) suffers a crack or damage as a result of repetitively driving the ultrasonic transducer.

An object of the present disclosure is to provide technologies that enable decrease in stress that is applied to a piezoelectric element owing to vibration of a resonator.

### Means for Solving the Problem

[1] A first ultrasonic transducer of the present invention includes: a base portion; a piezoelectric element joined to the base portion; a vibration plate joined to the piezoelectric element and configured to vibrate so as to generate an annular node; and a resonator joined to the vibration plate. The resonator is joined to a first surface, of the vibration plate, on one side in a thickness direction thereof. A surface, of the piezoelectric element, on a side opposite to a side on which the piezoelectric element is joined to the base portion, is joined to a second surface, of the vibration plate, on another side in the thickness direction thereof. A through-hole is formed in the piezoelectric element so as to penetrate therethrough in the thickness direction. In a planar direction orthogonal to the thickness direction, a joined portion between the vibration plate and the resonator is located inward of the node, and the through-hole is located inward of the node.

In this ultrasonic transducer, the joined portion between the vibration plate and the resonator is located inward of the node of vibration of the vibration plate. Due to this, stress is easily applied to the piezoelectric element on the inner side relative to the node. However, the through-hole of the piezoelectric element is formed in the region to which the stress from the joined portion is easily applied. Therefore, this ultrasonic transducer makes it possible to decrease stress that is applied to the piezoelectric element owing to vibration of the resonator.

[2] A second ultrasonic transducer of the present invention includes: a base portion; an interposed member having an annular shape and joined to the base portion; a piezoelectric element joined to the base portion with the interposed member interposed therebetween; a vibration plate joined to the piezoelectric element and configured to vibrate so as to generate an annular node; and a resonator joined to the vibration plate. A first surface, of the vibration plate, on one side in a thickness direction thereof is joined to the resonator. A second surface, of the vibration plate, on another side in the thickness direction thereof is joined to a surface, of the piezoelectric element, on a side opposite to a side on which the piezoelectric element is joined to the base portion. A through-hole is formed in the piezoelectric element so as to penetrate therethrough in the thickness direction. In a planar direction orthogonal to the thickness direction, a joined portion between the vibration plate and the resonator is located inward of an inscribed circle inscribed in the interposed member, and the through-hole is located inward of the inscribed circle.

In this ultrasonic transducer, the joined portion between the vibration plate and the resonator is located inward of the inscribed circle inscribed in the interposed member. Due to this, the vibration plate easily vibrates on the inner side relative to the inscribed circle inscribed in the interposed member, and stress is easily applied to the piezoelectric element on the inner side relative to the inscribed circle. However, the through-hole of the piezoelectric element is formed in the region to which the stress from the joined portion is easily applied. Therefore, this ultrasonic transducer makes it possible to decrease stress that is applied to the piezoelectric element owing to vibration of the resonator.

[3] At least a part of the joined portion may be located so as to overlap with the through-hole as seen in the thickness direction.

With this configuration, at least a part of the joined portion is located so as to overlap with the through-hole, and thus stress that is applied to the piezoelectric element owing to vibration of the resonator can be more effectively decreased.

[4] An entirety of the joined portion may be located so as to overlap with the through-hole as seen in the thickness direction.

With this configuration, since the entirety of the joined portion is located so as to overlap with the through-hole, stress that is applied to the piezoelectric element owing to vibration of the resonator can be more effectively decreased.

[5] The vibration plate may have a hole portion, and at least a part of the joined portion may be located so as to overlap with the hole portion as seen in the thickness direction.

With this configuration, it can be made easy for the vibration plate to vibrate, and the power consumption for causing vibration of the vibration plate can be decreased.

### Advantageous Effects of the Invention

The present invention makes it possible to decrease stress that is applied to the piezoelectric element owing to vibration of the resonator.

### BRIEF DESCRIPTION OF THE DRAWINGS

FIG. 1 is a cross-sectional view schematically showing an ultrasonic transducer in a first embodiment.

FIG. 2 is a plan view of a piezoelectric element in the first embodiment.

FIG. 3 is a plan view of the ultrasonic transducer in the first embodiment.

FIG. 4 is a plan view of a piezoelectric element in a second embodiment.

FIG. 5 is a plan view of an ultrasonic transducer in the second embodiment.

FIG. 6 is a plan view of a piezoelectric element in a third embodiment.

FIG. 7 is a plan view of an ultrasonic transducer in the third embodiment.

FIG. 8 is a cross-sectional view of a vibration plate, the piezoelectric element, and a resonator in a fourth embodiment.

FIG. 9 is a cross-sectional view of a vibration plate, the piezoelectric element, and the resonator in a fifth embodiment.

FIG. 10 is a cross-sectional view of a vibration plate, the piezoelectric element, and the resonator in a sixth embodiment.

### MODES FOR CARRYING OUT THE INVENTION

### First Embodiment

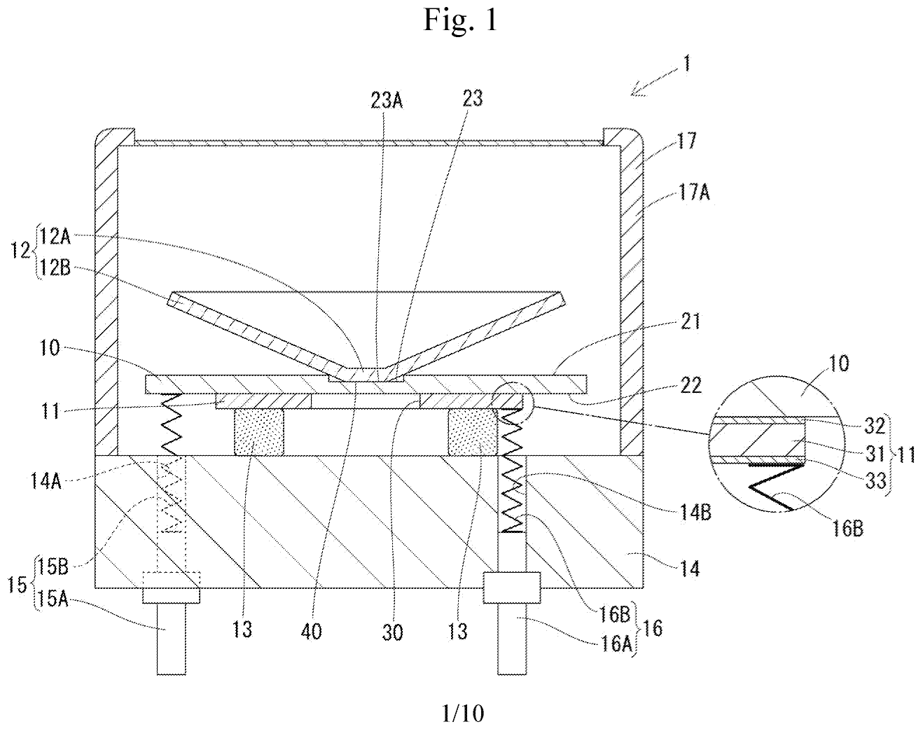

An ultrasonic transducer 1 shown in FIG. 1 is used for, for example, a medical or industrial ultrasonic device. The ultrasonic transducer 1 generates an ultrasonic wave upon receiving a drive signal, and converts, upon receiving an ultrasonic wave, the ultrasonic wave into an electric signal.

The ultrasonic transducer 1 includes a vibration plate 10, a piezoelectric element 11, a resonator 12, an interposed member 13, a base portion 14, a first wiring portion 15, a second wiring portion 16, and a case 17.

The vibration plate 10 has a plate shape (more specifically, a disc shape). The vibration plate 10 has electrical conductivity. The vibration plate 10 is made of, for example, a metal composed of a material such as 42 Alloy (42Ni—Fe). The width (maximum width) of the vibration plate 10 is larger than the width (maximum width) of each of the resonator 12, the interposed member 13, and the piezoelectric element 11. The width (maximum width) of the vibration plate 10 refers to the length (maximum length) of the vibration plate 10 in a direction orthogonal to a thickness direction thereof. In the present embodiment, the width (maximum width) of the vibration plate 10 is the diameter of the outer circumference of the vibration plate 10.

The vibration plate 10 vibrates so as to generate an annular (more specifically, ring-shaped) node 20. The vibration plate 10 generates only one annular node 20. The node 20 refers to a portion at which, when the vibration plate 10 vibrates, the displacement amount thereof in the plate thickness direction is smallest or no vibration occurs. The node 20 is uniquely determined according to the shapes and the materials of the vibration plate 10, the piezoelectric element 11, and the resonator 12. In FIG. 1, the piezoelectric element 11 is expressed in an exaggerated manner so as to look large, but is much smaller than the vibration plate 10 and the resonator 12, in actuality. Thus, the position of the node 20 is roughly determined according to the shapes and the materials of the vibration plate 10 and the resonator 12, and the shape and the material of the piezoelectric element 11 inflict little influence on determination of the position of the node 20. The outer circumferential edge of the vibration plate 10 is a free end. That is, the ultrasonic transducer 1 is of a so-called opened type and more easily vibrates than an ultrasonic transducer of a closed type in which the outer circumferential edge of the vibration plate 10 is fixed. The node 20 is generated inward of the outer circumferential edge of the vibration plate 10 and outward of the center of the vibration plate 10, in a planar direction orthogonal to the plate thickness direction. Vibration of the vibration plate 10 becomes more intense from the node 20 toward the outer circumferential edge and becomes more intense from the node 20 toward the center.

The vibration plate 10 has a first surface 21 on one side in the thickness direction and a second surface 22 on another side in the thickness direction. The resonator 12 is joined to the first surface 21. The piezoelectric element 11 is joined to the second surface 22. In the present description, the term “joined” conceptually encompasses not only a configuration in which joining is directly performed but also a configuration in which joining is performed via another member.

The vibration plate 10 has a hole portion 23. The hole portion 23 is formed in the first surface 21 and has a shape obtained by recessing the first surface 21. The hole portion 23 is formed by, for example, cutting. A cross section of the hole portion 23 taken along a plane orthogonal to the thickness direction of the vibration plate 10 has a circular shape and is unchanging in the thickness direction of the vibration plate 10.

The resonator 12 generates an ultrasonic wave by resonating according to vibration of the vibration plate 10. The resonator 12 has a function of increasing the efficiency of transmission of a sonic wave of the vibration plate 10 excited upon periodic power supply to the piezoelectric element 11. The resonator 12 is made of, for example, a metal composed of a material such as an aluminum alloy. The resonator 12 is joined to the vibration plate 10. The method for the joining is not limited and, for example, may involve adhesion with use of an adhesive such as an epoxy adhesive, or may involve soldering, ultrasonic welding, laser welding, or the like. The resonator 12 has a cone shape. The resonator 12 has a flat portion 12A and a tapered portion 12B. The flat portion 12A is flat and has a plate shape (more specifically, a disc shape). The flat portion 12A is joined to the first surface 21 of the vibration plate 10. The flat portion 12A has a shape for allowing the flat portion 12A to be accommodated in the hole portion 23 and is joined to a bottom surface 23A of the hole portion 23 formed in the first surface 21. The tapered portion 12B cylindrically extends from the outer circumferential edge of the flat portion 12A toward a side opposite to the vibration plate 10 side. The tapered portion 12B has a tapered shape such that the inner circumferential surface thereof becomes wider toward the side opposite to the vibration plate 10 side.

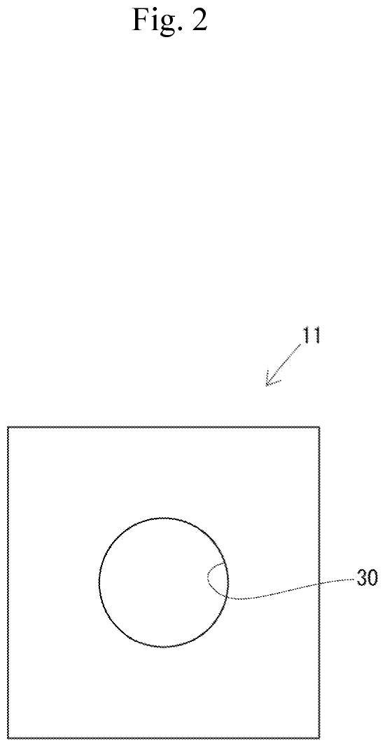

The piezoelectric element 11 has a plate shape and is joined so as to be stacked on the vibration plate 10. The piezoelectric element 11 is joined to the vibration plate 10 with use of a thermosetting epoxy adhesive or the like. As shown in FIG. 2, the piezoelectric element 11 has a rectangular shape as seen in the thickness direction of the vibration plate 10. A through-hole 30 is formed in the piezoelectric element 11 so as to penetrate therethrough in the thickness direction of the vibration plate 10. A cross section of the through-hole 30 taken along a plane in a direction orthogonal to the direction of the penetration has a circular shape. As shown in FIG. 1, the piezoelectric element 11 has a piezoelectric body 31 having a plate shape and electrodes 32 and 33 provided on both respective sides in the thickness direction of the piezoelectric body 31. The piezoelectric body 31 is made of, for example, a ceramic such as lead zirconate titanate (PZT) or potassium sodium niobate (KNN). The electrode 32 which is one of the electrodes 32 and 33 provided to both sides of the piezoelectric element 11 is joined to the vibration plate 10 and electrically connected to the first wiring portion 15 via the vibration plate 10. The electrode 33 which is the other one, different from the electrode 32, of the electrodes provided to both sides of the piezoelectric element 11 is electrically connected to the second wiring portion 16. To a surface, of the piezoelectric element 11, on the side opposite to the vibration plate 10 side, the base portion 14 is joined with the interposed member 13 interposed therebetween.

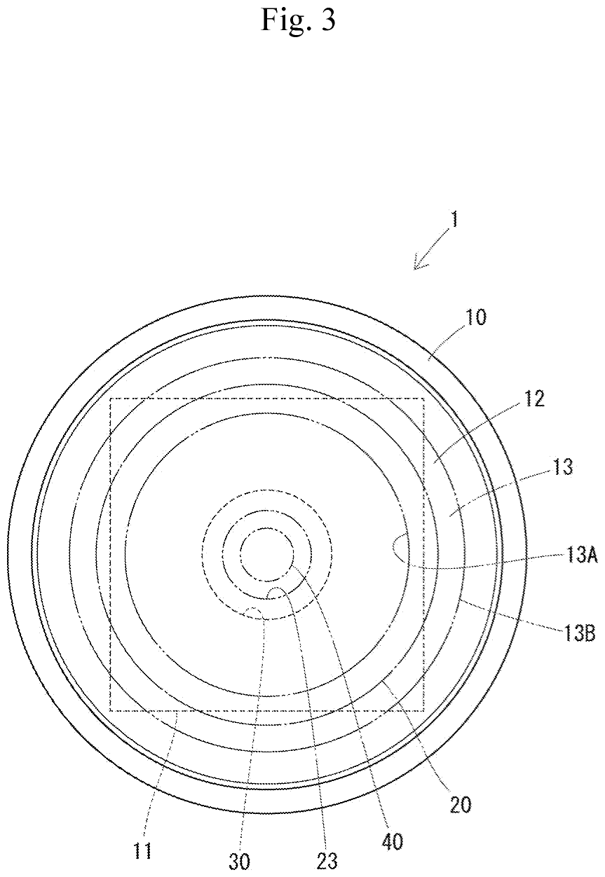

The interposed member 13 is disposed between the piezoelectric element 11 and the base portion 14 and joined to each of the piezoelectric element 11 and the base portion 14. The interposed member 13 has insulating properties and elasticity. The interposed member 13 has a lower Young's modulus than the base portion 14. The interposed member 13 is made of, for example, a rubber such as silicone rubber, a resin such as a silicon-based adhesive, or the like. The interposed member 13 has an annular shape (more specifically, a ring shape). An axial direction of the interposed member 13 extends along the thickness direction of the vibration plate 10, and more specifically, coincides with the thickness direction of the vibration plate 10. The interposed member 13 is disposed such that the node 20 of vibration of the vibration plate 10 is located between an inscribed circle 13A inscribed in the interposed member 13 and a circumcircle 13B circumscribing the interposed member 13 in the planar direction orthogonal to the plate thickness direction of the vibration plate 10 (see FIG. 3).

The base portion 14 is made of a synthetic resin and is formed as a resin base. The base portion 14 has a plate shape. A thickness direction of the base portion 14 extends along the thickness direction of the vibration plate 10, and more specifically, coincides with the thickness direction of the vibration plate 10.

The first wiring portion 15 has a first terminal 15A and a first coil spring 15B each made of a metal. A first base through-hole 14A is formed in the base portion 14 so as to penetrate therethrough in the thickness direction. The first wiring portion 15 is inserted through the first base through-hole 14A. The first terminal 15A is fixed to the base portion 14 at a position at which an opening, of the first base through-hole 14A, on the side opposite to the vibration plate 10 side is closed. An expansion/contraction direction of the first coil spring 15B extends along the thickness direction of the vibration plate 10, and more specifically, coincides with the thickness direction. The first coil spring 15B is sandwiched between the vibration plate 10 and the first terminal 15A, and is disposed in a state of being compressed by being pressed from the vibration plate 10 and the first terminal 15A. The first coil spring 15B has one end in contact with the vibration plate 10 and has another end in contact with the first terminal 15A. The first wiring portion 15 is electrically connected to one electrically-conductive path out of a positive-electrode-side electrically-conductive path and a negative-electrode-side electrically-conductive path (for example, a ground).

The second wiring portion 16 has a second terminal 16A and a second coil spring 16B each made of a metal. A second base through-hole 14B is formed in the base portion 14 so as to penetrate therethrough in the thickness direction. The second wiring portion 16 is inserted through the second base through-hole 14B. The second terminal 16A is fixed to the base portion 14 at a position at which an opening, of the second base through-hole 14B, on the side opposite to the vibration plate 10 side is closed. An expansion/contraction direction of the second coil spring 16B extends along the thickness direction of the vibration plate 10, and more specifically, coincides with the thickness direction. The second coil spring 16B is sandwiched between the piezoelectric element 11 and the second terminal 16A, and is disposed in a state of being compressed by being pressed from the piezoelectric element 11 and the second terminal 16A. The second coil spring 16B has one end in contact with a surface, of the piezoelectric element 11, on the side opposite to the vibration plate 10 side (i.e., the electrode 33 of the piezoelectric element 11) and has another end in contact with the second terminal 16A. The second wiring portion 16 is electrically connected to the other electrically-conductive path out of the positive-electrode-side electrically-conductive path and the negative-electrode-side electrically-conductive path (for example, the ground).

The case 17 is a member for protecting the resonator 12 so as not to allow foreign matter to come into contact with the resonator 12. The case 17 is fixed to the base portion 14. The case 17 has a peripheral wall portion 17A enclosing the surrounding of the resonator 12. A plurality of openings is formed, in the case 17, on a side opposite to the base portion 14 side relative to the resonator 12. Through the openings, ultrasonic waves are transmitted to outside and ultrasonic waves enter the case 17 from outside.

As shown in FIG. 3, in the planar direction orthogonal to the thickness direction of the vibration plate 10, a joined portion 40 between the vibration plate 10 and the resonator 12 is located inward of the node 20, and the through-hole 30 of the piezoelectric element 11 is located inward of the node 20. In addition, in the planar direction, the joined portion 40 between the vibration plate 10 and the resonator 12 is located inward of the inscribed circle 13A inscribed in the interposed member 13, and the through-hole 30 is located inward of the inscribed circle 13A. In addition, the entirety of the joined portion 40 is located so as to overlap with the through-hole 30 as seen in the thickness direction of the vibration plate 10. In addition, the entirety of the joined portion 40 is located so as to overlap with the hole portion 23 as seen in the thickness direction of the vibration plate 10.

The following descriptions are related to advantageous effects of the first embodiment.

In the ultrasonic transducer 1 in the first embodiment, the joined portion 40 between the vibration plate 10 and the resonator 12 is located inward of the node 20 of vibration of the vibration plate 10. Due to this, stress is easily applied to the piezoelectric element 11 on the inner side relative to the node 20. However, the through-hole 30 of the piezoelectric element 11 is formed in the region to which the stress from the joined portion 40 is easily applied. Therefore, this ultrasonic transducer 1 makes it possible to decrease stress that is applied to the piezoelectric element 11 owing to vibration of the resonator 12.

In addition, in the ultrasonic transducer 1 in the first embodiment, the joined portion 40 between the vibration plate 10 and the resonator 12 is located inward of the inscribed circle 13A inscribed in the interposed member 13. Due to this, the vibration plate 10 easily vibrates on the inner side relative to the inscribed circle 13A inscribed in the interposed member 13, and stress is easily applied to the piezoelectric element 11 on the inner side relative to the inscribed circle 13A. However, the through-hole 30 of the piezoelectric element 11 is formed in the region to which the stress from the joined portion 40 is easily applied. Therefore, this ultrasonic transducer 1 makes it possible to decrease stress that is applied to the piezoelectric element 11 owing to vibration of the resonator 12.

Furthermore, the entirety of the joined portion 40 is located so as to overlap with the through-hole 30 as seen in the thickness direction of the vibration plate 10. Since the entirety of the joined portion 40 is located so as to overlap with the through-hole 30, stress that is applied to the piezoelectric element 11 owing to vibration of the resonator 12 can be more effectively decreased.

Furthermore, the entirety of the joined portion 40 is located so as to overlap with the hole portion 23 as seen in the thickness direction of the vibration plate 10. Consequently, it can be made easy for the vibration plate 10 to vibrate, and the power consumption for causing vibration of the vibration plate 10 can be decreased.

### Second Embodiment

In the first embodiment, the entirety of the joined portion is located so as to overlap with the through-hole as seen in the thickness direction of the vibration plate. However, the configuration in which the entirety of the joined portion is located so as to overlap with the through-hole does not have to be employed. In a second embodiment, an example in which a part of the joined portion is located so as to overlap with the through-hole as seen in the thickness direction of the vibration plate, will be described. An ultrasonic transducer in the second embodiment differs from the ultrasonic transducer in the first embodiment only in terms of the shape of the piezoelectric element. The other features are common to both ultrasonic transducers. In the following descriptions, the same constituents as those in the first embodiment are denoted by the same reference characters, and detailed explanations thereof are omitted.

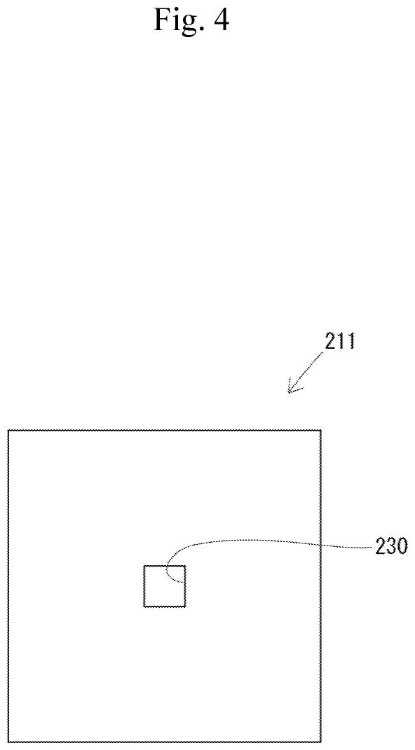

As shown in FIG. 4, a piezoelectric element 211 in the second embodiment has a rectangular shape as seen in the thickness direction of the vibration plate 10. A through-hole 230 is formed in the piezoelectric element 211 so as to penetrate therethrough in the thickness direction of the vibration plate 10. The shape of a cross section of the through-hole 230 taken along a plane orthogonal to the direction of the penetration by the through-hole 230 is a rectangular shape.

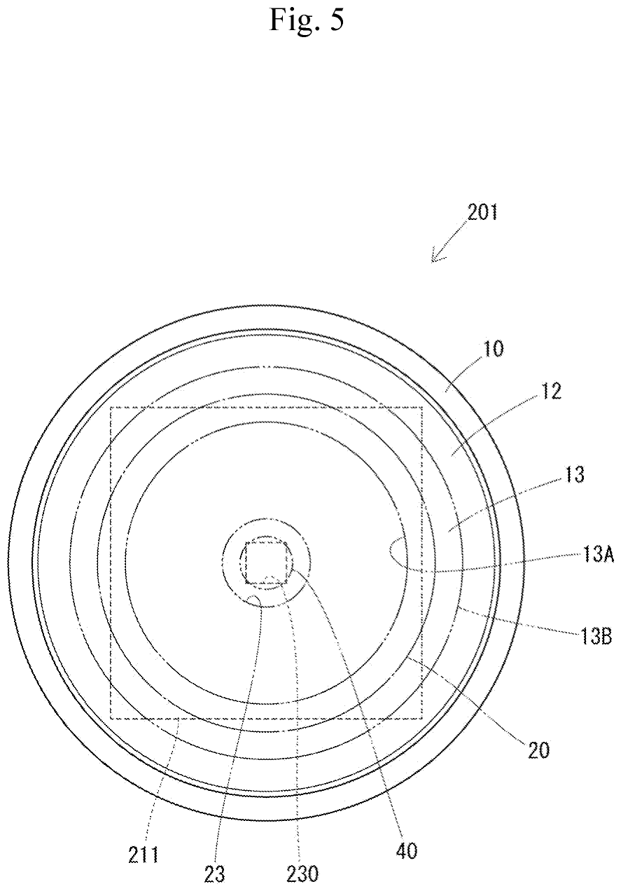

As shown in FIG. 5, a part of the joined portion 40 between the vibration plate 10 and the resonator 12 is located so as to overlap with the through-hole 230 as seen in the thickness direction of the vibration plate 10. The through-hole 230 has portions that do not overlap with the joined portion 40 as seen in the thickness direction of the vibration plate 10.

As described above, in an ultrasonic transducer 201 in the second embodiment, a part of the joined portion 40 is located so as to overlap with the through-hole 230 as seen in the thickness direction. Consequently, in the ultrasonic transducer 201, stress that is applied to the piezoelectric element 211 owing to vibration of the resonator 12 can be more effectively decreased as compared with a configuration in which the joined portion 40 is located so as not to overlap with the through-hole 230 at all.

### Third Embodiment

In the first embodiment, the number of through-holes formed in the piezoelectric element is one. However, the number may be two or more. In a third embodiment, an example in which a plurality of through-holes is formed in the piezoelectric element will be described. An ultrasonic transducer in the third embodiment differs from the ultrasonic transducer in the first embodiment only in terms of the shape of the piezoelectric element. The other features are common to both ultrasonic transducers. In the following descriptions, the same constituents as those in the first embodiment are denoted by the same reference characters, and detailed explanations thereof are omitted.

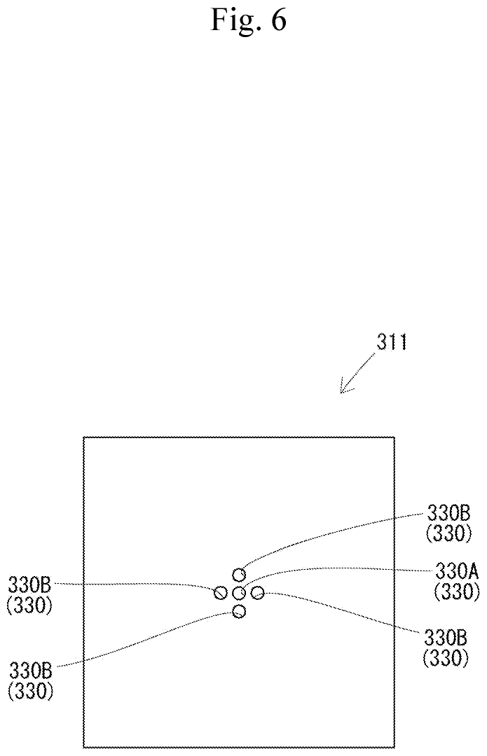

As shown in FIG. 6, a piezoelectric element 311 in the third embodiment has a rectangular shape as seen in the thickness direction of the vibration plate 10. A through-hole 330 is formed in the piezoelectric element 311 so as to penetrate therethrough in the thickness direction of the vibration plate 10. The shape of a cross section of the through-hole 330 taken along a plane orthogonal to the direction of the penetration by the through-hole 330 is a circular shape. A plurality of (in the present embodiment, five) through-holes 330 is formed in the piezoelectric element 311. More specifically, one through-hole 330A is formed at the center of the piezoelectric element 311, and four through-holes 330B are formed around the through-hole 330A.

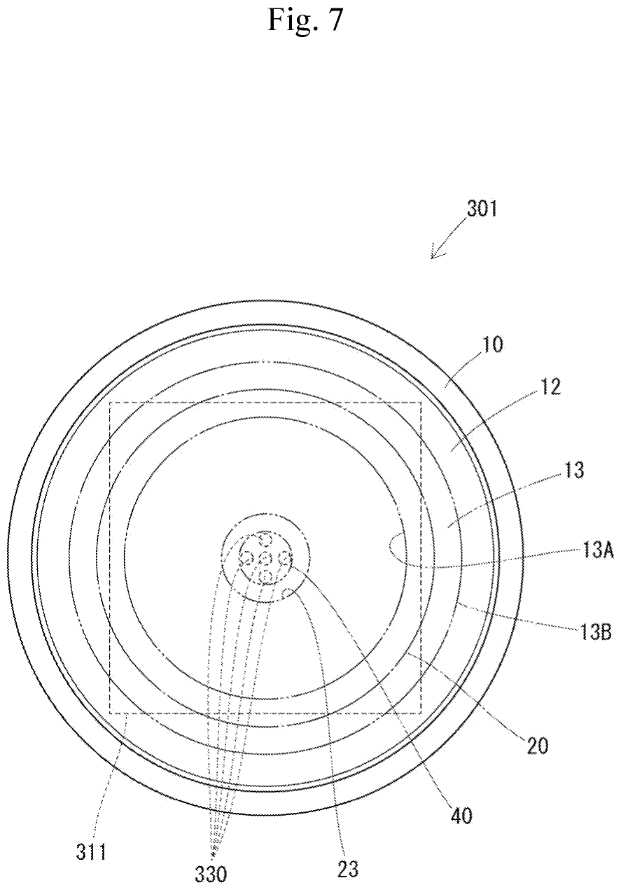

As shown in FIG. 7, a part of the joined portion 40 between the vibration plate 10 and the resonator 12 is located so as to overlap with the through-holes 330 as seen in the thickness direction of the vibration plate 10.

As described above, in an ultrasonic transducer 301 in the third embodiment, a part of the joined portion 40 is located so as to overlap with the through-holes 330 as seen in the thickness direction. Consequently, in the ultrasonic transducer 301, stress that is applied to the piezoelectric element 311 owing to vibration of the resonator 12 can be more effectively decreased as compared with a configuration in which the joined portion 40 is located so as not to overlap with the through-holes 330 at all.

### Fourth Embodiment

The first embodiment employs a configuration in which the vibration plate has a hole portion. However, a configuration in which the vibration plate has no hole portion may be employed. An ultrasonic transducer in a fourth embodiment differs from the ultrasonic transducer in the first embodiment in that the vibration plate has no hole portion. The other features are common to both ultrasonic transducers. In the following descriptions, the same constituents as those in the first embodiment are denoted by the same reference characters, and detailed explanations thereof are omitted.

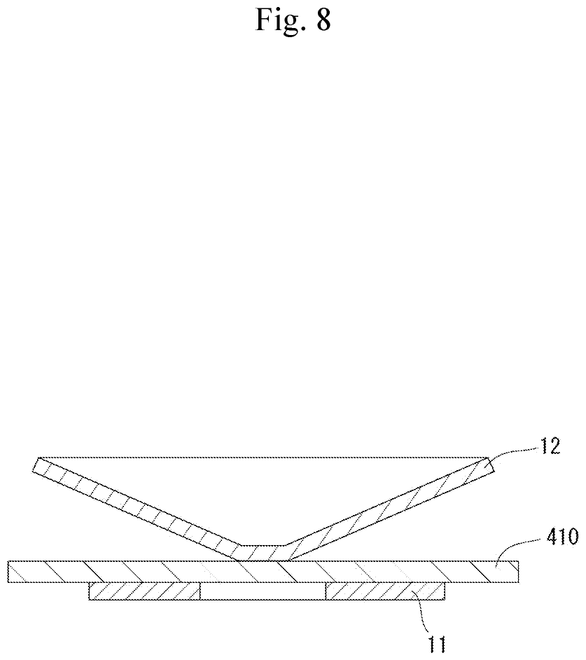

As shown in FIG. 8, the ultrasonic transducer in the fourth embodiment includes a vibration plate 410, the piezoelectric element 11, and the resonator 12. The vibration plate 410 has the same configuration as that of the vibration plate 10 in the first embodiment, except that the vibration plate 410 has no hole portion. That is, both surfaces in the thickness direction of the vibration plate 410 are flat. The thickness of the vibration plate 410 is uniform over the entirety of the vibration plate 410. In the ultrasonic transducer in the fourth embodiment, the vibration plate 410 has no hole portion, and thus the vibration plate 410 is easily formed.

### Fifth Embodiment

The first embodiment employs a configuration in which the hole portion of the vibration plate is formed by cutting. However, a configuration in which the hole portion of the vibration plate is formed by another method may be employed. In a fifth embodiment, an example in which the hole portion of the vibration plate is formed by half-blanking will be described. An ultrasonic transducer in the fifth embodiment differs from the ultrasonic transducer in the first embodiment in that the hole portion of the vibration plate is formed by half-blanking. The other features are common to both ultrasonic transducers. In the following descriptions, the same constituents as those in the first embodiment are denoted by the same reference characters, and detailed explanations thereof are omitted.

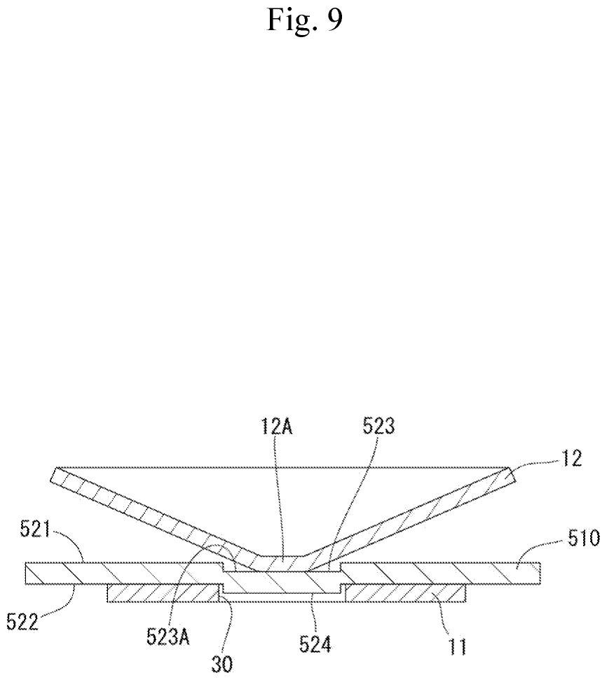

As shown in FIG. 9, the ultrasonic transducer in the fifth embodiment includes a vibration plate 510, the piezoelectric element 11, and the resonator 12. The vibration plate 510 has a first surface 521 on one side in the thickness direction and a second surface 522 on another side in the thickness direction. The resonator 12 is joined to the first surface 521. The piezoelectric element 11 is joined to the second surface 522.

The vibration plate 510 has a hole portion 523 and a protruding portion 524. The hole portion 523 is formed in the first surface 521 and has a shape obtained by recessing the first surface 521. The hole portion 523 is formed by half-blanking. A cross section of the hole portion 523 taken along a plane orthogonal to the thickness direction of the vibration plate 510 has a circular shape and is unchanging in the thickness direction of the vibration plate 510. The flat portion 12A of the resonator 12 is fitted into the hole portion 523 and joined to a bottom surface 523A of the hole portion 523.

The protruding portion 524 is formed on the second surface 522. At least a part of the protruding portion 524 is located so as to overlap with the hole portion 523 as seen in the thickness direction of the vibration plate 510. The protruding portion 524 is formed when the hole portion 523 is formed by half-blanking. The protruding portion 524 is fitted into the through-hole 30 of the piezoelectric element 11. The protrusion dimension of the protruding portion 524 is smaller than the thickness of the piezoelectric element 11. Therefore, the protruding portion 524 does not protrude outward of the through-hole 30.

In the ultrasonic transducer in the fifth embodiment, chips are less likely to be generated as compared with a case where the hole portion of the vibration plate is formed by cutting.

### Sixth Embodiment

The first embodiment employs a configuration in which the hole portion of the vibration plate does not penetrate the vibration plate. However, a configuration in which the hole portion penetrates the vibration plate may be employed. In a sixth embodiment, an example in which the hole portion of the vibration plate penetrates the vibration plate will be described. An ultrasonic transducer in the sixth embodiment differs from the ultrasonic transducer in the first embodiment in that the hole portion of the vibration plate penetrates the vibration plate. The other features are common to both ultrasonic transducers. In the following descriptions, the same constituents as those in the first embodiment are denoted by the same reference characters, and detailed explanations thereof are omitted.

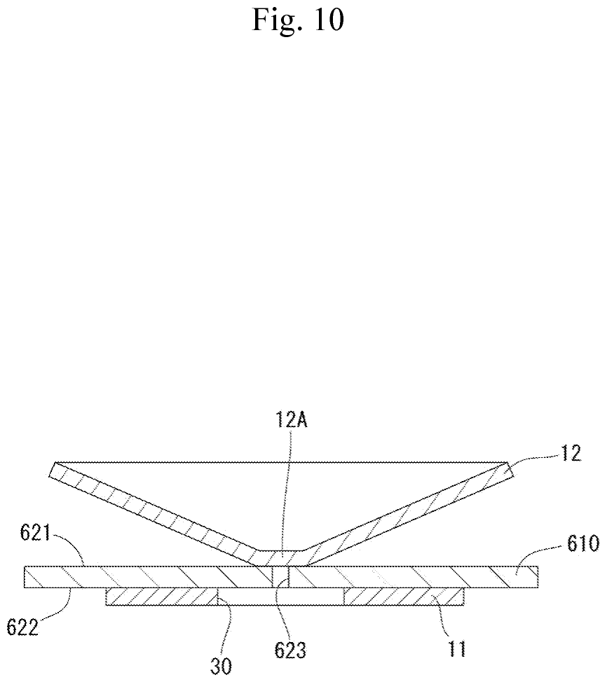

As shown in FIG. 10, the ultrasonic transducer in the sixth embodiment includes a vibration plate 610, the piezoelectric element 11, and the resonator 12. The vibration plate 610 has a first surface 621 on one side in the thickness direction and a second surface 622 on another side in the thickness direction. The resonator 12 is joined to the first surface 621. The piezoelectric element 11 is joined to the second surface 622.

The vibration plate 610 has a hole portion 623. The hole portion 623 is formed so as to penetrate the vibration plate 610 in the thickness direction thereof. The hole portion 623 is located on the inner side relative to the outer circumferential edge of the flat portion 12A of the resonator 12, in the planar direction orthogonal to the thickness direction of the vibration plate 610. The hole portion 623 is located on the inner side relative to the inner wall of the through-hole 30, in the planar direction orthogonal to the thickness direction of the vibration plate 610. A cross section of the hole portion 623 taken along a plane orthogonal to the thickness direction of the vibration plate 610 has a circular shape and is unchanging in the thickness direction of the vibration plate 610.

### Other Embodiments

The present invention is not limited to the embodiments explained by means of the above descriptions and drawings, and, for example, embodiments described below are also encompassed in the technical scope of the present invention. In addition, various features in the above embodiments and the embodiments described later may be combined in any way as long as the combination does not lead to any contradiction.

Each of the above embodiments employs a configuration in which at least a part of the joined portion is located so as to overlap with the through-hole as seen in the thickness direction of the vibration plate. However, a configuration in which the joined portion is located so as not to overlap with the through-hole at all may be employed.

Each of the above embodiments employs a configuration in which either of the first coil spring and the second coil spring is not joined. However, a configuration in which these springs are joined may be employed. The method for the joining is not limited and involves, for example, soldering, laser welding, ultrasonic welding, or the like.

The embodiments disclosed herein are merely illustrative in all aspects and should not be recognized as being restrictive. The scope of the present invention is not limited by the embodiments disclosed herein and is intended to encompass the scope defined by the claims and all modifications made within the scope equivalent to the scope of the claims.

### DESCRIPTION OF REFERENCE NUMERALS

1: ultrasonic transducer
10: vibration plate
11: piezoelectric element
12: resonator
12A: flat portion
12B: tapered portion
13: interposed member
13A: inscribed circle
13B: circumcircle
14: base portion
14A: first base through-hole
14B: second base through-hole
15: first wiring portion
15A: first terminal
15B: first coil spring
16: second wiring portion
16A: second terminal
16B: second coil spring
17: case
17A: peripheral wall portion
20: node
21: first surface
22: second surface
23: hole portion
23A: bottom surface
30: through-hole
31: piezoelectric body
32: electrode
33: electrode
40: joined portion
201: ultrasonic transducer
211: piezoelectric element
230: through-hole
301: ultrasonic transducer
311: piezoelectric element
330: through-hole
330A: through-hole
330B: through-hole
410: vibration plate
510: vibration plate
521: first surface
522: second surface
523: hole portion
610: vibration plate
621: first surface
622: second surface
623: hole portion

1. An ultrasonic transducer comprising:
a base portion;
a piezoelectric element joined to the base portion;
a vibration plate joined to the piezoelectric element and configured to vibrate so as to generate an annular node; and
a resonator joined to the vibration plate, wherein
the resonator is joined to a first surface, of the vibration plate, on one side in a thickness direction thereof,
a surface, of the piezoelectric element, on a side opposite to a side on which the piezoelectric element is joined to the base portion, is joined to a second surface, of the vibration plate, on another side in the thickness direction thereof,
a through-hole is formed in the piezoelectric element so as to penetrate therethrough in the thickness direction, and,
in a planar direction orthogonal to the thickness direction, a joined portion between the vibration plate and the resonator is located inward of the node, and the through-hole is located inward of the node.

2. An ultrasonic transducer comprising:
a base portion;
an interposed member having an annular shape and joined to the base portion;
a piezoelectric element joined to the base portion with the interposed member interposed therebetween;
a vibration plate joined to the piezoelectric element and configured to vibrate so as to generate an annular node; and
a resonator joined to the vibration plate, wherein
a first surface, of the vibration plate, on one side in a thickness direction thereof is joined to the resonator,
a second surface, of the vibration plate, on another side in the thickness direction thereof is joined to a surface, of the piezoelectric element, on a side opposite to a side on which the piezoelectric element is joined to the base portion,
a through-hole is formed in the piezoelectric element so as to penetrate therethrough in the thickness direction, and,
in a planar direction orthogonal to the thickness direction, a joined portion between the vibration plate and the resonator is located inward of an inscribed circle inscribed in the interposed member, and the through-hole is located inward of the inscribed circle.

3. The ultrasonic transducer according to claim 1, wherein
at least a part of the joined portion is located so as to overlap with the through-hole as seen in the thickness direction.

4. The ultrasonic transducer according to claim 3, wherein
an entirety of the joined portion is located so as to overlap with the through-hole as seen in the thickness direction.

5. The ultrasonic transducer according to claim 1, wherein
the vibration plate has a hole portion, and
at least a part of the joined portion is located so as to overlap with the hole portion as seen in the thickness direction.
